(19) United States
(12) Patent Application Publication
(10) Pub. No.: US 2011/0163528 A1
(43) Pub. Date: Jul. 7, 2011

(54) Recording Material for Laser Printing Process

(75) Inventors: Christoph Kozlowski, Osnabruck (DE); Rainer Steinbeck, Osnabruck (DE); Andreas Overberg, Osnabruck (DE)

(73) Assignee: Felix Schoeller jr. Foto-und Spezialpapiere GmbH & Co. KG, Osnabruck (DE)

(21) Appl. No.: 13/119,465

(22) PCT Filed: Sep. 16, 2009
(86) PCT No.: PCT/EP09/61988

§ 371 Date: Mar. 17, 2011

(30) Foreign Application Priority Data
Sep. 19, 2008 (EP) 08105391.0

(51) Int. Cl. B42D 1/00; B32B 3/00; B05D 5/04

(52) U.S. Cl. 281/38; 428/141; 427/209

(57) ABSTRACT

Recording materials for electrophotographic methods, comprising a raw paper coated on both sides with a synthetic resin and a toner-sensitive layer, wherein the synthetic resin-coated paper has a specific surface topography, expressed as a roughness Rz of 1.5 to 13 μm, and an average Ra value of 0.05 to 2 μm, the toner-absorbing layer comprises a polymer combination of a toner-absorbing ethylene-acrylic acid copolymer (A), a carboxylated acrylic acid ester copolymer (B) and a polymer (C), and polymer (C) has an average particle size d_{50%} of 5 to 20 μm and a melting point that is higher than the melting range of copolymer (A) and lower than the melting range of copolymer (B).

The invention relates to a recording material for electrophotographic recording processes, in particular for the laser printing process, having a resin-coated paper substrate and a toner-receiving layer, and to the use of the recording material for producing photo books.

The principle of electrophotography forms the basis of the laser printer. Electrophotography uses the visual image of an original document to produce a latent image consisting of electric charges by imaging or exposing a photoconductor, the latent image being subsequently used to selectively apply a toner (development) and to produce an image (copy) of the original document, for example on paper. A distinction is made between direct and indirect and between wet and dry electrophotography. The wet processes use a suspension consisting of an aliphatic solvent with little relative permittivity and the toner, while the dry process uses a powder.

An image of the desired page is plotted onto the light-sensitive image cylinder by means of a directed laser beam and a rotating mirror. The cylinder is initially negatively charged, wherein the electric charge is reversed at the places where the laser beam strikes. The form of the discharged areas on the cylinder corresponds to the later print-out. The toner is delivered to the cylinder via a roller with negatively charged toner which sticks to the discharged places on the image cylinder. The paper is then guided over the image cylinder. It only brushes past the cylinder. A potential field is built up behind the paper. The toner is transferred onto the paper and is initially loose there. The toner is subsequently fused by means of a hot roller and under pressure. The cylinder is discharged and excess toner is collected.

The images produced by means of a laser printer should obtain a quality which can be compared to a photo. In order to get closer to this aim, images created electrophotographically are produced on substrates which have the surface feel and appearance of a typical silver salt photo. This includes properties such as gloss, stiffness and opacity, a high resolution and image definition and good light resistance.

In DE 44 35 350 C2, an image-receiving material for electrophotography is described, which comprises a base paper coated with thermoplastics and a toner-receiving layer and an anti-static rear side layer. The disadvantage of this material is that it can only be printed on on one side and is in need of improvement with regard to toner fusing and behaviour in the printer.

The resin-coated base papers used as the substrate in the recording materials usually consist of a sized raw paper which is preferably coated on both sides with polyolefin by means of (co-)extrusion. Thermoplastic polymers, such as low density polyethylene (LDPE), ethylene/α-olefin copolymer (so-called low linear density polyethylene (LLDPE), high density polyethylene (HDPE) and polypropylene, are usually used for the extrusion coating of the raw paper.

If the recording paper printed with toner is covered directly after printing, then unwanted transfer of the toner particles on the rear side of the material which is lying on top often occurs. In practice, the printed paper is, for example, covered when storing the fresh print in plastic film packaging, albums or when stacking a plurality of prints in the printer.

So-called photo books, which can be created individually, are part of the most recent developments in the field of image formation which are finding a ready market. A wide selection of printing techniques and the recording materials used for this purpose, in particular the photo paper, are available to create such photo books.

A photo base paper coated with photographic emulsions is used for producing such photo books, on the front side of which, images are wet chemically produced according to the conventional silver salt process. The paper sheets provided with images on the front side in the next step are stuck together on the rear sides and are bound together to form a book. This is laborious and time-consuming and is associated with higher production costs. Therefore, coated, calendered paper, which can be printed on on both sides and which can be printed on by an electrophotographic process, is used for producing the photo books. The images produced in this procedure are, however, in need of improvement with regard to the colour density, the light stability and ozone stability and behaviour in the print device (feeding, conveying and stacking).

It is therefore the object of the invention to provide a recording material which can be printed on on both sides, has a good image quality, a good light resistance and ozone resistance when storing, as well as good feeding in and conveying behaviour in the printer and good stackability.

This object is achieved by a recording material which contains a raw paper coated with a synthetic resin on both sides and a toner-receiving layer, wherein the synthetic resin coated paper has a specific surface topography expressed by a roughness value Rz of 1.5 to 13 μm and a mean roughness index Ra of 0.05 to 2 μm, the toner-receiving layer contains a polymer combination consisting of a toner-receiving ethylene acrylic acid copolymer (A), a carboxylated acrylic ester copolymer (B) and a polymer (C), and polymer (C) has an average particle size d_{50%} of 5 to 20 μm and a melting point which is above the melting range of copolymer (A) and below the melting range of copolymer (B).

For the purposes of the invention, the term “raw paper” is understood to mean an uncoated or surface-sized paper. Raw paper, in addition to pulp fibres, can contain sizing agents, such as alkyl ketene dimers, fatty acids and/or fatty acid salts, epoxidised fatty acid amides, alkenyl or alkyl succinic acid anhydride, wet strength agents, such as polyamine-polyamide-epichlorohydrin, dry strength agents, such as anionic, cationic or amphoteric polyamides, optical brighteners, fillers, pigments, dyes, anti-foaming agents and other additives known in the paper industry. The raw paper can be surface-sized. Sizing agents suitable for this purpose are, for example, polyvinyl alcohol or oxidised starch. The raw paper can be produced on a Fourdrinier or a Yankee paper machine (cylinder paper machine). The grammage of the raw paper can be 50 to 250 g/m², in particular 80 to 180 g/m². The raw paper can be used in uncompacted or compacted form (calendered). Raw paper with a density of 0.8 to 1.2 g/cm³, in particular 0.90 to 1.1 g/cm³, is especially well suited.

Bleached hardwood kraft pulp (LBKP), bleached softwood kraft pulp (NBKP), bleached hardwood sulphite pulp (LBSP) or bleached softwood sulphite pulp (NBSP) can, for example, be used as the pulp fibres. These can also be used in a mixed form. However, pulp fibres consisting of 100% hardwood pulp are in particular used. The average fibre length of the unground pulp is preferably 0.6 to 0.85 mm (Kajaani measurement). Furthermore, the pulp has a lignin content of less than 0.05% wt., in particular 0.01 to 0.03% wt., based on the mass of the pulp.

Kaolins, calcium carbonate in its natural forms, such as limestone, marble or dolomite brick, Paris white, calcium sulphate, barium sulphate, titanium dioxide, talc, silica, aluminium oxide and mixtures thereof, can be used as fillers in the raw paper. Calcium carbonate having a grain size distribution, in which at least 60% of the particles are less than 2 μm and at most 40% are less than 1 μm, is particularly suitable. In one particular embodiment of the invention, calcite, having a grain size distribution in which about 25% of the particles have a particle size of less than 1 μm and about 85% of the particles have a particle size of less than 2 μm, is used.

The synthetic resin layers arranged on both sides of the raw paper (front side and rear side synthetic resin layers) can preferably contain a thermoplastic polymer. Polyolefins, for example low density polyethylene (LDPE), high density polyethylene (HDPE), polypropylene, 4-methylpentene-1 and mixtures thereof, as well as polyesters, such as polycarbonates, are particularly suitable for this purpose.

In one particular embodiment of the invention, the front side and rear side synthetic resin layers contain at least 40% wt. HDPE with a density of more than 0.935 g/cm³, in particular 50 to 70% wt. A composition is particularly preferred which consists of 50% wt. HDPE with a density of more than 0.935 g/cm³ and 50% wt. LDPE with a density of less than 0.935 g/cm³.

The synthetic resin layers can contain white pigments, such as titanium oxide and other additives like optical brighteners, dyes and dispersing agents. The coat weight of the synthetic resin layers can be 5 to 50 g/m², in particular 5 to 30 g/m², preferably, however, 10 to 20 g/m². The synthetic resin layer can be extruded as a single layer or co-extruded as multiple layers. The extrusion coating can be carried out at machine speeds of up to 600 m/min.

According to the invention, the synthetic resin layers are applied symmetrically on both sides of the raw paper, i.e. the front side and the rear side synthetic resin layers have the same composition. These layers are also identical with regard to surface topography.

The surface structure (topography) is created by means of the cooling cylinders used during the extrusion coating. It can be characterised by roughness values.

In one particular embodiment, the surface of the synthetic resin layer has on both sides roughness values Rz of 1.8 to 11 μm and a mean roughness index Ra of 0.1 to 1.8 μm.

The cooling cylinders used to create the surface structure are produced in the known way. To that end, the surface of a steel cylinder can be treated by blasting with sand, glass or another blasting material and then chromium-plated. The surface of the cylinder can also, however, be electrolytically formed in the conventional way in a chrome bath.

Polymer (A) of the polymer combination in the ink-receiving layer preferably has a melting range of 70 to 100° C. and polymer (B) a melting range of 160 to 210° C.

Polymer (B) can be characterised by a so-called acid number. The amount of free carboxyl groups contained in the polymer is defined by an acid number. It specifies the amount (mg) of a 0.1 molar KOH solution which is required to neutralise the free acid groups in 1 g of polymer. The polymer (B) used according to the invention has an acid number of more than 100. Polymers having an acid number of 120 to 160 are particularly well suited.

Polymers (A) and (B) are preferably used in a proportion of 70:30 to 30:70. Particularly good effects were obtained with a proportion of 60:40 to 40:60.

Polymer (C) preferably has a melting point in a temperature range from 120 to 150° C. Polyethylene waxes, polyamides and mixtures thereof are particularly well suited for this purpose.

Polymer (C) is preferably used in an amount of 0.1 to 5% wt., in particular 1.0 to 4.0% wt., based on the dried layer.

In one preferred exemplary embodiment of the invention, an anti-static agent is contained in an amount 0.1 to 5.0% wt., in particular 1.0 to 4.0% wt., based on the dried layer, in the toner-receiving layer.

In a further exemplary embodiment of the invention, the toner-receiving layer additionally contains anionic or non-ionic surface-active agents in an amount of 0.1 to 4.0% wt., in particular 0.5 to 2.5% wt., based on the dried layer.

The toner-receiving layer can also, if required, contain other additives, for example matting agents, pigments, dyes, cross-linking agents, anti-blocking agents and other common additives.

The coating compound used to form the toner-receiving layer can be applied in-line or off-line with all coating devices customary in paper production, wherein the amount is chosen such that after drying the coat weight at most is 3 g/m², in particular 0.1 to 2 g/m², or according to one particularly preferred exemplary embodiment, 0.3 to 0.7 g/m². In one preferred exemplary embodiment, the coating compound is applied as a coat by means of a customary coating head integrated within the extrusion coating line. A 3-roll application or a doctor blade device is particularly well suited for this purpose.

In a further exemplary embodiment of the invention, a pigment-containing layer can be arranged between the raw paper and the synthetic resin layer. The pigment can be a metal oxide, silicate, carbonate, sulphide or sulphate. Pigments like kaolins, talc, calcium carbonate and/or barium sulphate are particularly well suited.

A pigment with a narrow grain size distribution, in which at least 70% of the pigment particles are of a size which is less than 1 μm, is particularly preferred. The proportion of the pigment with the narrow grain size distribution is at least 5% wt., in particular 10% to 90% wt., of the total pigment amount. Particularly good results can be obtained with a proportion of 30 to 80% wt. of the total pigment.

Pigments with a narrow grain size distribution are also, according to the invention, understood to mean pigments with a grain size distribution in which at least about 70% wt. of the pigment particles are of a size which is less than about 1 μm and with 40 to 80% wt. of these pigment particles the difference between the pigment with the greatest grain size (diameter) and the pigment with the smallest grain size is less than about 0.4 μm. A calcium carbonate with a d_{50%} value of about 0.7 μm has proven to be particularly advantageous.

In one particular exemplary embodiment of the invention, a pigment mixture can be used in the pigment-containing layer, which consists of the abovementioned calcium carbonate and kaolin. The proportion of calcium carbonate/kaolin is preferably 30:70 to 70:30.

The proportion of binder/pigment in the pigment-containing layer can be 0.1 to 2.5, preferably 0.2 to 1.5, in particular, however, about 0.9 to 1.3.

Any known water-soluble and/or water-dispersible binder can be used in the pigment-containing layer. Film-forming starches, such as thermally-modified starches, in particular maize starches or hydroxypropylated starches, are particularly suitable for this purpose.

The pigment-containing layer can be applied in-line or off-line with all coating devices customary in paper production, wherein the amount is chosen such that after drying the coat weight is 0.1 to 30 g/m², in particular 1 to 20 g/m², or according to one particularly preferred exemplary embodiment, 2 to 8 g/m². In one preferred exemplary embodiment, the pigment-containing layer is applied with a size press or film press integrated within the paper machine.

In a further embodiment of the invention, further layers, such as protective layers or gloss-improving layers, can be applied to the toner-receiving layer. The coat weight is preferably less than 1 g/m².

The following examples are given to explain the invention in more detail.

### EXAMPLES

Production of the raw paper

Eucalyptus pulp was used to produce the raw paper. For refining, the pulp was ground as an approximately 5% aqueous suspension (thick stock) by means of a refiner to a freeness value of 35° SR. The average fibre length was 0.65 mm. The concentration of the pulp fibres in the thin stock was 1% wt. based on the mass of the pulp suspension. Additives were added to the thin stock, such as a neutral sizing agent alkyl ketene dimer (AKD) in an amount of 0.48% wt., a wet strength agent polyamine-polyamide-epichlorohydrin resin (Kymene®) in an amount of 0.36% wt. and a natural CaCO₃ in an amount of 20% wt. The quantities relate to the pulp mass. The thin stock, whose pH was adjusted to about 7.5, was conveyed from the headbox onto the wire of the paper machine, whereupon the sheet forming took place by draining the web in the wire section of the paper machine. In the press section, the paper web was drained further to a water content of 60% wt., based on the web weight. Further drying took place in the drier section of the paper machine with heated drying cylinders. A raw paper was created with a grammage of 163 g/m² and a moisture content of about 6%.

### Examples B1 and B2

The raw paper was coated in the conventional way on both sides with a synthetic resin mixture consisting of the following composition: 50% wt. of a low density polyethylene (LDPE, d=0.923 g/m²) and 50% wt. of a high density polyethylene (HDPE, d=0.964 g/cm³). The coating was carried out in a laminator (tandem extruder) at an extrusion speed of 250 m/min using a cooling cylinder from BEP Service Technology, the surface of which had an average Rz value of 11.03 μm and an Ra index of 1.87 μm. The surface of the cooling cylinder was created by sand blasting or blasting with another blasting material and chromium-plated. The coat weights on both sides were in each case 15 g/m².

The toner-receiving layer was subsequently applied by means of a roll applicator integrated within the extrusion line. For this, aqueous coating compounds having a solids content of 19% wt. were used with the following compositions:

| | B1 % wt. | B2% wt. |
|---|---|---|
| | (absolutely | (absolutely |
| Composition | dry) | dry) |
| Ethylene acrylic acid copolymer *) | 46.51 | 46.72 |
| Melting point 75° C. (according | | |
| to DSC) , T_{g} = −7° C. | | |
| Carboxylated acrylic ester **) | 46.44 | 46.65 |
| Melting point 180° C. (according | | |
| to DSC) | | |
| T_{g} = 105° C. | | |
| HD polyethylene wax ***) | 1.80 | — |
| Melting point 124-134° C. (ac- | | |
| cording to DSC) | | |
| d_{50%} = 5.5-7.5 μm | | |
| Polyamide/polyethylene mixture ****) | — | 1.36 |
| Melting point 137-143° C. (ac- | | |
| cording to DSC) | | |
| d_{50%} = 13.0-15.0 μm | | |
| LiNO₃ | 3.16 | 3.17 |
| Na-dioctylsulphosuccinate, 65% | 1.81 | 1.82 |
| in water | | |
| Dimethylpolysiloxane, 70% in | 0.28 | 0.28 |
| water | | |

*) obtainable as an aqueous dispersion having a solids content of 32% wt.
**) obtainable as an aqueous emulsion having a solids content of 50% wt.
***) obtainable as an aqueous dispersion having a solids content of 60% wt.
****) obtainable as an aqueous dispersion having a solids content of 45% wt.

The coat weight of the dried toner-receiving layer was on both sides in each case 0.5 g/m².

### Comparison Examples

### Comparison Example 1

For comparison, Zander Silver Digital, a commercially available recording material for electrophotographic applications, was used.

### Comparison Example 2

For comparison, Zander Profi Gloss, a commercially available recording material for electrophotographic applications, was used.

### Testing of the Recording Materials Produced According to the Examples and the Comparison Examples

The material produced according to the invention was tested for image quality, light resistance and ozone resistance.

Colour prints were the basis of the tests, which were produced with the HP Color Laser Jet 2605dn (wet toner) laser printer and the Konica Minolta MC5550 colour copier. Bar-like areas were printed in the colours cyan, magenta, yellow, red, green, blue and black at 100% ink saturation.

Ozone Resistance

The printed paper samples were stored for 24 hours free from the effects of light, gas and humidity. Then, the colorimetric L*a*b* values of the coloured areas were determined.

In the next step, the samples were stored for 24 hours in an ozone chamber at an ozone concentration of 3.5 ppm, at a temperature of 20 to 22° C. and at a relative air humidity of 40 to 50%. Then, the colorimetric L*a*b* values of the coloured areas were measured again and the degree of fading ΔE determined.

L*a*b* values were measured with an X-Rite Color Digital Swatchbook (X-Rite Inc., Grandville, Mich., USA). The colour tone difference ΔE was calculated according to the equation:

ΔE=((ΔL*)²+(Δa)²+(Δb*)²)^{1/2}.

The test results are compiled in Table 1.

Light resistance

The printed paper samples were kept under a xenon lamp for 50 hours at a temperature of 26° C. and at a relative light resistance of 60%. The assessment was carried out according to the CIE L*a*b* system described above.

Test Results

TABLE I
Light resistance

| Optical den- | | | | | |
|---|---|---|---|---|---|
| sity | Before exposure | | After exposure | | Difference |
| Zanders Sil- | Cyan | 1.40 | Cyan | 1.4 | 0.0 |
| ver Digital | Magenta | 1.37 | Magenta | 1.28 | 0.09 |
| | Yellow | 0.94 | Yellow | 0.87 | 0.07 |
| | Black | 1.52 | Black | 1.51 | 0.01 |
| | Unprinted | 0.03 | | 0.05 | −0.02 |
| Printed mate- | Cyan | 1.39 | Cyan | 1.39 | 0.0 |
| rial of the | Magenta | 1.37 | Magenta | 1.33 | 0.04 |
| invention | Yellow | 0.9 | Yellow | 0.85 | 0.05 |
| | Black | 1.64 | Black | 1.6 | 0.04 |
| | Unprinted | 0.0 | | 0.0 | 0.0 |
| Zanders Profi | Unprinted | 0.03 | | 0.05 | −0.02 |
| Gloss | | | | | |

TABLE 2
Ozone resistance

| | | Before ozone treatment | | | After ozone treatment | | | |
|---|---|---|---|---|---|---|---|---|
| Sample | Colour | L | a | b | L | a | b | ΔE |
| Zanders | Cyan | 62.92 | −37.61 | −44.11 | 62.38 | −38.99 | −41.79 | 2.75 |
| Silver | Magenta | 50.94 | 70.53 | −9.39 | 51.09 | 67.91 | −7.96 | 3.26 |
| Digital | Yellow | 90.47 | −4.63 | 96.84 | 90.07 | −4.74 | 89.96 | 6.89 |
| | Red | 48.3 | 65.22 | 48.61 | 48.35 | 63.98 | 45.43 | 3.41 |
| | Green | 52.53 | −69.71 | 36.46 | 53.02 | −69.82 | 32.36 | 4.13 |
| | Blue | 25.19 | 22.58 | −45.89 | 24.62 | 22.02 | −45.74 | 0.81 |
| | Black | 19.95 | 1.05 | −1.78 | 20.89 | 0.78 | −3.29 | 1.80 |
| | Unprinted | 98.58 | 1.04 | −6.7 | 97.03 | −0.38 | 2.22 | 9.16 |
| Material | Cyan | 65.06 | −38.17 | −45.57 | 65.03 | −39.02 | −44.06 | 1.73 |
| according | Magenta | 51.5 | 72.97 | −11.22 | 51.52 | 71.37 | −11.3 | 1.60 |
| to the in- | Yellow | 92.71 | −4.93 | 98.45 | 92.94 | −5.57 | 92.85 | 5.64 |
| vention | Black | 16.77 | −0.73 | 2.01 | 17.47 | −0.02 | 3.53 | 1.82 |
| | Unprinted | 100.4 | 1.42 | −7.75 | 99.99 | 0.63 | −3.7 | 4.16 |
| Zanders | Unprinted | 98.67 | 1.01 | −6.74 | 96.79 | −0.36 | 2.59 | 9.62 |
| Profi | | | | | | | | |
| Gloss | | | | | | | | |

1.-36. (canceled)

37. Recording material for electrophotographic processes, containing a raw paper coated with a synthetic resin on both sides and a toner-receiving layer, comprising a synthetic resin coated paper having a specific surface topography expressed by a roughness value Rz of 1.5 to 13 μm and a mean roughness index Ra of 0.05 to 2 μm, the toner-receiving layer contains a
polymer combination consisting of a toner-receiving ethylene acrylic acid copolymer (A),
a carboxylated acrylic ester copolymer (B),
and a polymer (C),
and polymer (C) has an average particle size d50% of 5 to 20 μm and a melting point which is above the melting range of copolymer (A) and below the melting range of copolymer (B).

38. Recording material according to claim 37, wherein the melting range of copolymer (A) is 70 to 100° C. and of copolymer (B) is 160 to 210° C.

39. Recording material according to claim 38, wherein the melting point of polymer (C) is in a range from 120 to 150° C.

40. Recording material according to claim 39, wherein polymer (C) is a polyethylene wax, a polyamide or a mixture thereof.

41. Recording material according to claim 37, wherein the toner-receiving layer contains an anti-static agent.

42. Recording material according to claim 41, wherein the anti-static agent is an alkali metal salt of an inorganic acid.

43. Recording material according to claim 42, wherein the toner-receiving layer contains an anionic or non-ionic surfactant.

44. Recording material according to claim 41, wherein the toner-receiving layer contains inorganic particles.

45. Recording material according to claim 37, wherein the front side and rear side synthetic resin layers contain a thermoplastic polymer which is selected from the group of polyolefins and polycarbonates.

46. Recording material according to claim 45, wherein the thermoplastic polymer is a high density polyethylene (HDPE) or a 4-methylpentene-1.

47. Recording material according to claim 46, wherein the front side and rear side synthetic resin layers contain at least 40% wt. HDPE with a density of more than 0.935 g/cm³.

48. Recording material according to claim 47, wherein the front side and rear side synthetic resin layers contain 50% wt. HDPE with a density of more than 0.935 g/cm³ and 50% wt. LDPE with a density of 0.935 g/cm³ or less, based on the total synthetic resin layer.

49. Recording material according to claim 48, wherein the front side and rear side synthetic resin layers contain a white pigment.

50. Recording material according to claim 37, wherein a pigment-containing layer is arranged between the raw paper and the synthetic resin layer.

51. A process for producing a recording material, which contains a raw paper, coated with a synthetic resin layer on both sides, and at least one toner-receiving layer, applied to the recording material from a coating solution and arranged on both sides, wherein the process for producing the recording material comprises the following work steps:
coating the front side and rear side of the raw paper with at least one synthetic resin layer, wherein the composition and the surface topography of the synthetic resin layers are the same on both sides,
coating the front side and rear side synthetic resin layers with at least one toner-receiving layer wherein the toner-receiving layer contains a
polymer combination consisting of a toner-receiving ethylene acrylic acid copolymer (A),
a carboxylated acrylic ester copolymer (B),
and a polymer (C),
and polymer (C) has an average particle size d50% of 5 to 20 μm and a melting point which is above the melting range of copolymer (A) and below the melting range of copolymer (B).

52. The process according to claim 51, wherein the surface topography has a roughness value Rz of 1.5 to 13 μm and a mean roughness index Ra of 0.05 to 2 μm.

53. The process according to claim 52, wherein the front side and rear side synthetic resin layers contain at least 40% wt. HDPE with a density of more than 0.935 g/cm³.

54. A process according to claim 51, wherein a pigment-containing layer is applied between the raw paper and the synthetic resin layer.

55. Recording material according to claim 37, used as a Photo book.
